(19) United States
(12) Patent Application Publication
(10) Pub. No.: US 2010/0034166 A1
(43) Pub. Date: Feb. 11, 2010

(54) WIRELESS COMMUNICATION METHOD AND SYSTEM FOR SUPPORTING CALL CONTINUITY

(75) Inventor: Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: Interdigital Technology Corporation, Wilmington, DE (US)

(21) Appl. No.: 12/377,978

(22) PCT Filed: Sep. 20, 2006
(86) PCT No.: PCT/US06/36986

§ 371 Date: Feb. 18, 2009

Related U.S. Application Data
(60) Provisional application No. 60/720,270, filed on Sep. 23, 2005.

(51) Int. Cl. H04W 36/00; H04W 4/00

(52) U.S. Cl. 370/331; 370/338

(57) ABSTRACT

A method and system for supporting a handover between a circuit-switched (CS) domain and an Internet protocol (IP) multimedia subsystem (IMS) domain to provide call continuity are disclosed. The system includes a wireless transmit/receive unit (WTRU) and a wireless network. The WTRU includes a call continuity control entity for supporting call continuity between a CS domain and an IMS domain, and a media independent handover (MIH) entity configured to provide MIH services for providing information in a media independent manner. The wireless network includes an MIH entity for providing MIH services for collecting and forwarding information in a media independent manner. A handover between the CS domain and the IMS domain is triggered based on information obtained via MIH services from the MIH entities. The information may be exchanged via an MIH information server.

### FIELD OF INVENTION

The present invention is related to a wireless communication system. More particularly, the present invention is related to a method and system for supporting a handover between a circuit-switched (CS) domain and an Internet protocol (IP) multimedia subsystem (IMS) domain to provide call continuity.

### BACKGROUND

Wireless network operators manage a cellular wireless network to provide CS and packet-switched (PS) services to their subscribers. Generally, voice services may be provided over either a CS network or a PS network. However, the wireless network operators do not want to provide voice services over the PS network as both the CS network and the PS network compete for the same resources.

An alternative access network, such as a wireless local area network (WLAN), may be used to relieve voice traffic load on the CS network. For example, the voice services may be provided either over the CS network in a CS domain or via the WLAN in an IMS domain.

Voice services need to be delivered seamlessly when a user moves across the boundaries of the CS network and the WLAN. This problem has been addressed by the Third Generation Partnership Project (3GPP) technical report (TR) 23.806 which is directed to voice call continuity between CS and IP multimedia subsystem (IMS). The 3GPP TR 23.806 attempts to solve the problem of providing seamless voice call continuity by introducing new network functions, (e.g., a call continuity control function (CCCF) and a network domain selection (NeDS) function), and anchoring two voice paths between the IMS domain and the CS domain.

The CCCF supports call continuity between the CS domain and the IMS domain using an IP connectivity access network (CAN). The CCCF is a logical functional entity which must exist for each voice continuity call. The CCCF receives and processes call continuity requests, and establishes or releases call legs needed to transfer a voice call from the CS domain to the IMS domain, or visa versa. The NeDS function is the control point for selecting which domain to use for terminating a call.

The main problem with the solutions provided by the 3GPP TR 23.806 is that it is assumed that a user equipment (UE) will be able to determine the point in time when a handover must occur. However, there is no mention regarding how these procedures are executed and what triggers them. It is not clear how the UE determines the best possible network candidate to establish a new connection, either for initial call set up or a handover between the CS domain and the IMS domain.

In addition, there are no procedures or functionality defined in the 3GPP TR 23.806 to generate triggers toward upper layers, based on state changes, and there are no procedures defined regarding how multi-technology information is delivered from a single network element without having to retrieve this information from a multiplicity of servers.

### SUMMARY

The present invention is related to a method and system for supporting a handover between a CS domain and an IMS domain to provide call continuity. The system includes a wireless transmit/receive unit (WTRU) and wireless network. The WTRU includes a call continuity control entity for supporting call continuity between a CS domain and an IMS domain, and a media independent handover (MIH) entity configured to provide MIH services for providing information in a media independent manner. The wireless network includes an MIH entity for providing MIH services for collecting and forwarding information in a media independent manner. A handover between the CS domain and the IMS domain is triggered based on information obtained via MIH services from the MIH entities. The information may be exchanged via an MIH information server.

### BRIEF DESCRIPTION OF THE DRAWINGS

FIG. 1 shows an exemplary wireless communication system configured in accordance with the present invention.

FIGS. 2 and 3 show alternative implementations of the IMS in accordance with the present invention.

FIG. 4 shows interaction between a WTRU and the network elements of the system of FIG. 1.

FIG. 5 is a flow diagram of a process of implementing a user-initiated handover from an IMS domain to a CS domain in accordance with the present invention.

FIG. 6 is a flow diagram of a process of implementing a network-initiated handover from an IMS domain to a CS domain in accordance with the present invention.

### DETAILED DESCRIPTION OF THE PREFERRED EMBODIMENTS

When referred to hereafter, the terminology “WTRU” includes but is not limited to a UE, a mobile station (STA), a fixed or mobile subscriber unit, a pager, or any other type of device capable of operating in a wireless environment. When referred to hereafter, the terminology “access point” (AP) includes but is not limited to a Node-B, a base station, a site controller or any other type of interfacing device in a wireless environment.

The features of the present invention may be incorporated into an integrated circuit (IC) or be configured in a circuit comprising a multitude of interconnecting components.

The present invention is applicable to any wireless communication system including, but not limited to, IEEE 802 based systems, cellular systems, (such as 3GPP or 3GPP2 and their long term evolution (LTE)), and other standardized or proprietary wireless systems, (such as Bluethooth™, HIPERLAN/2, or the like).

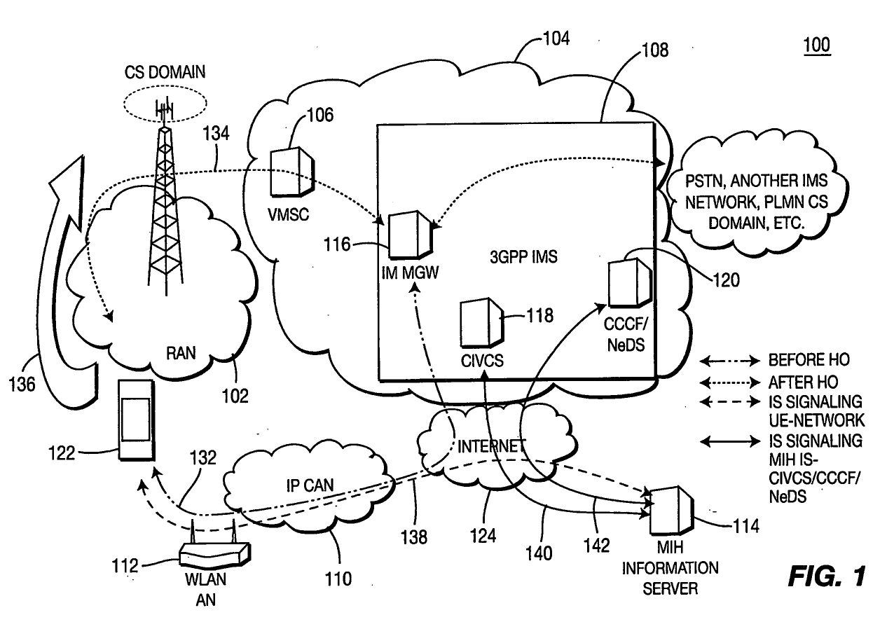

FIG. 1 shows an exemplary wireless communication system 100 configured in accordance with the present invention. The system 100 includes a 3GPP radio access network (RAN) 102, a 3GPP core network 104 (which includes a mobile switching center (MSC) 106 and a 3GPP IMS 108), an Internet protocol (IP) connectivity access network (CAN) 110 with a WLAN, a WLAN AP 112, and an MIH information server 114. The 3GPP IMS 108 includes an IP multimedia media gateway (IM-MGW) 116, a CS IMS voice continuity service (CIVCS) entity 118, and a CCCF/NeDS entity 120. The 3GPP RAN 102 may be a universal mobile telecommunication services (UMTS) terrestrial radio access network (UTRAN), a global standards for mobile communication (GSM)/enhanced datarate for GSM evolution (EDGE) radio access network (GERAN), or the like.

It should be noted that the system 100 shown in FIG. 1 is provided as an example and the scope of the present invention should not be limited to the specific example shown in FIG. 1. For example, FIG. 1 depicts that the IP multimedia services are provided in an IMS domain via the IP CAN 110. However, the IP multimedia services may be provided over the 3GPP RAN 102.

A WTRU 122 may establish a voice call either in an IMS domain via the IP CAN 110 or in a CS domain via the 3GPP RAN 102. FIG. 1 illustrates a handover from an IMS domain to a CS domain. A call is initially established in the IMS domain and the WTRU 122 is connected to the IM MGW 116 via the IP CAN 110 and the Internet 124, as shown by arrow 132. After a handover, (as shown by an arrow 136), the call is switched to the CS domain and the WTRU 122 is connected to the IM MGW 116 via the 3GPP RAN 102 and the MSC 106, as shown by arrow 134. The IM MGW 116 is connected to other portions of the CS domain network, such as a public switched telephone network (PSTN), another IMS network, a public land mobile network CS domain, or the like.

In accordance with the present invention, voice call continuity (VCC) is improved by using IEEE 802.21 MIH functions and services. The MIH information server 114 obtains information from the WTRU 122 via MIH services, (i.e., information service (IS), command service (CS) and event service (ES)), as shown by an arrow 138, and exchanges necessary information to the CIVCS entity 118 and the CCCF/NeDS entity 120 via MIH services, as shown by arrows 140, 142, which will be explained in detail hereinafter.

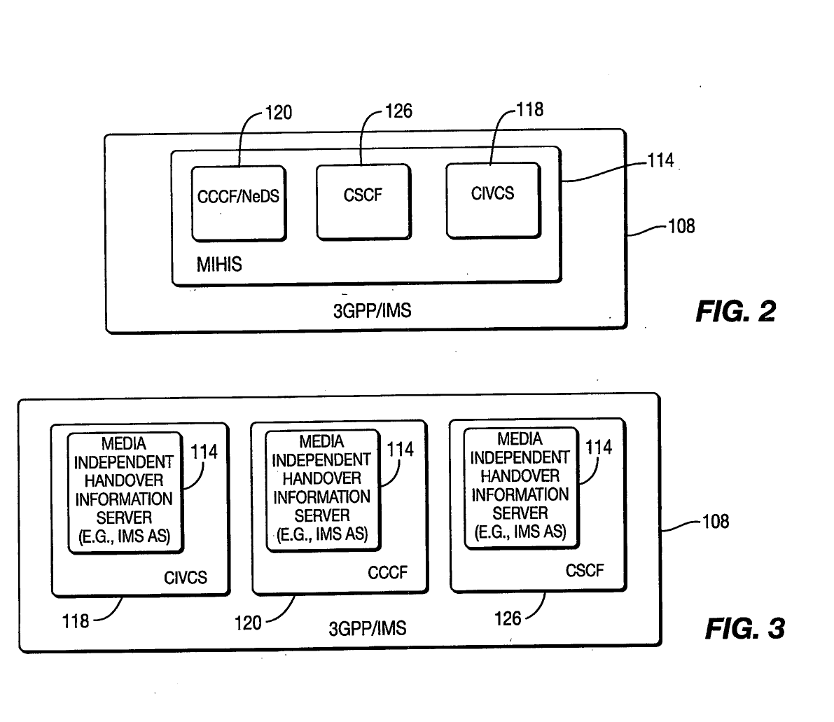

The MIH information server 114 may be located in any entities in the system 100, (e.g., the CCCF/NeDS entity 120 or the CIVCS entity 118). FIGS. 2 and 3 show alternative implementations of the IMS 108 in accordance with the present invention. The MIH information server 114 may include the CCCF/NeDS entity 120, a call session control function (CSCF) entity 126 and the CIVCS entity 118, as shown in FIG. 2. Alternatively, the CIVCS entity 118, the CCCF/NeDS entity 120 and the CSCF entity 126 may include a separate MIH information server 114, respectively, as shown in FIG. 3. The CCCF entity and the NeDS entity may be one entity or separate entities.

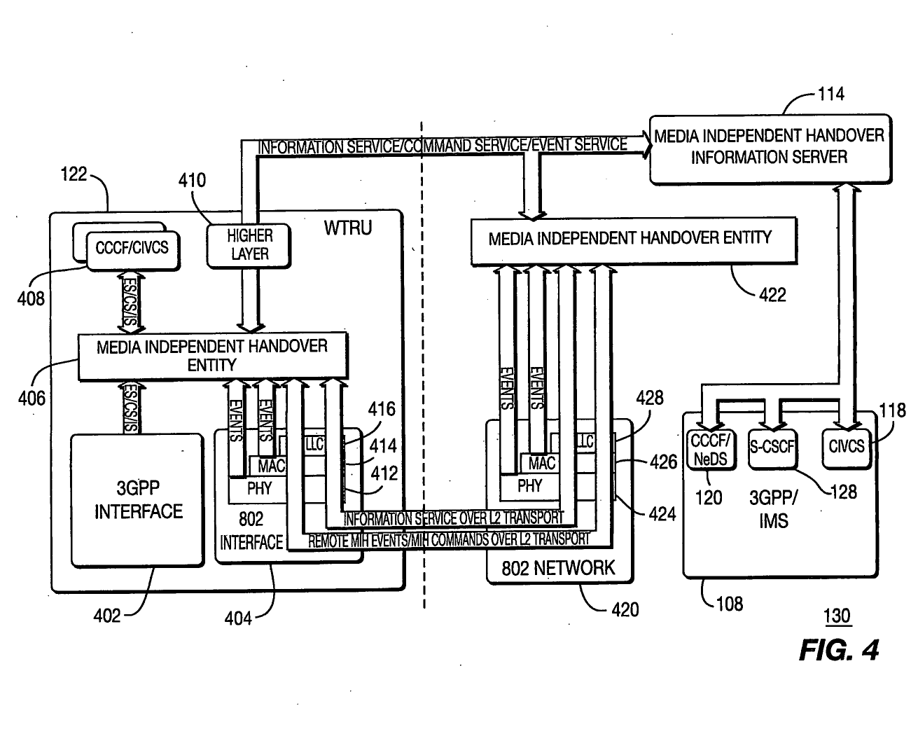

FIG. 4 shows interaction between the WTRU 122 and the network entities of the system 100 in FIG. 1. The WTRU 122 includes a 3GPP interface 402, an IEEE 802 interface 404, an MIH entity 406, a CCCF/CIVCS entity 408 and a higher layer 410. The IEEE 802 interface 404 includes a physical (PHY) layer 412, a medium access control (MAC) layer 414 and a logical link control (LLC) layer 416. The 3GPP/IMS interface 402 provides ES, CS and IS to the MIH entity 406. Local information generated by the PHY layer 412 and the MAC layer 414 is provided to the MIH entity 406 via ES, and remote information received from MIH entity 422 in the network 130 over L2 transport is communicated to the MIH entity 406 via IS, CS and ES.

The MIH entity 406 is included in the WTRU 122 to support seamless handover between heterogeneous networks by providing handover related information in a media independent manner. The MIH entity 406 is a layer-independent entity and may work independently as a sole handover management entity or may coordinate with a conventional technology-specific handover entity.

The MIH entity 406 in the WTRU 122 receives local handover information, commands and events from the 3GPP interface 402 and the IEEE 802 interface 404 and exchanges remote information, commands and events with the MIH entity 422 of the network 130. The CCCF/CIVCS 408 of the WTRU 122 may trigger a handover based on the collected information, commands and events using the MIH services.

The handover events and information may be any events or information relevant to handover. For example, if an unrecoverable failure condition occurs in the network 130, the network 130 may signal this occurrence to the WTRU 122 so that the WTRU 122 may switch to a different network interface, (i.e., different call domain). Another example is an existence of alternative networks with better radio/service condition, (e.g., better price or better QoS).

The network 130 includes an IEEE 802 network 420, a 3GPP IMS 108, an MIH entity 422 and an MIH information server 114. The MIH entity 422 in the network 130 may exist separately or may reside in any entity, such as an AP (not shown) of the IEEE 802 network 420. The IEEE 802 network 420 includes an LLC layer 428, a MAC layer 426, a PHY layer 424. In the network 130, local handover events, information and commands are communicated between the MAC layer 426 and the PHY layer 424 and the MIH entity 422 by IS, CS and ES, and remote handover information, events and commands are exchanged between the MIH entity 422 and the MIH entity 406 of the WTRU 122 over L2 transport.

The MIH information server 114 may reside in any entity within the network that is able to operate according to the IEEE 802.21 protocol. The MIH information server 114 handles messages used by any of the MIH services, (i.e., ES, IS and CS). The MIH information server 114 communicates the handover information, commands and events with the MIH entity 422 of the network 130 and the MIH entity 406 of the WTRU 122 by an IS, CS and ES. The MIH information server 114 also exchanges information with the 3GPP/IMS 108 using a higher layer transport protocol. For example, the MIH information server 114 may generate handover commands and information and send them to the MIH entity 422 of the network 130, and the MIH entity 422 of the network 130 may generate remote events and inter-technology network information requests.

The CCCF/NeDS entity 120, the serving call state control function (S-CSCF) entity 128 and the CIVCS entity 118 receive MIH services, (i.e., IS, CS and ES), from the MIH information server 114. By defining an interface between the CCCF/NeDS entity 120, the S-CSCF entity 128 and the CIVCS entity 118 and the MIH information server 114, seamless real time exchange of the media independent network information is possible and a handover may be triggered quickly.

The MIH information server 114 provides the CCCF/NeDS 120 with information regarding domain and capabilities of the WTRU 122, (such as media types supported by the WTRU 122, (e.g., voice and video capabilities over IMS, voice capabilities over CS and codec type)), network operator policies and user preferences to select an optimal match between the network and the WTRU 122.

The MIH information server 114 also provides the CCCF/NeDS 120 with information regarding WTRU status with respect to the CS network, (i.e., whether the WTRU 122 is in a detached state, an attached-idle state or an attached-active state). This information may be used to determine the domain where a terminating service request should be provided. The MIH information server 114 may update this information in real time using the MIH event service and MIH information service.

In accordance with the 3GPP TR 23.806, the WTRU 122 and the CCCF/NeDS 120 exchange information using mobility event package (MEP) to update each other the needed information. In accordance with the present invention, the information between the WTRU 122 and the CCCF/NeDS entity 120 is exchanged through the MIH information server 114 and the MEP is implemented by using the MIH services, (i.e., IS, CS and ES).

During an IMS registration process to originate a call in an IMS domain, the S-CSCF entity assigns a CCCF to the WTRU 122. In accordance with the present invention, the MIH information server 114 provides neighboring information and location information of the WTRU 122 to the S-CSCF entity to aid the S-CSCF entity in selection of an optimal CCCF. An optimal CCCF is assigned to the WTRU 122 based on a combination of geographical location, user and operator preferences and the QoS of the available networks.

The WTRU 122 sends an invite request to a relevant proxy call state control function (P-CSCF) which is determined by the P-CSCF discovery mechanism. In accordance with the present invention, the MIH information services are used to discover the relevant P-CSCF. The MIH information server 114 itself may be found using an MIH fully qualified domain name (FQDN) assigned to the WTRU 122 upon subscription. Once the MIH information server 114 is available, the specific address, (i.e., IP address), of the relevant P-CSCF may be retrieved directly using the MIH information service from the MIH information server 114. The IP CAN 110 may provide the discovery mechanism as part of the establishment of the connectivity towards the IP CAN.

An initial filter criteria is stored in a home subscriber server (HSS) (not shown) as part of the CS-IMS user service subscription profile and downloaded to the currently assigned S-CSCF at the time of the user's registration with the IMS 108. The relevant filter criteria required for the selection of the relevant CCCF/NeDS entity may be retrieved directly from the MIH information server 114 via MIH services.

The MIH function and its IS, CS and ES may be used as a means to provide a policy decision entity, (e.g., an application server acting as a policy decision point), with necessary information, such as operator and subscriber preferences and policies, through the MIH information services. For example, MIH IS may be used to provide the policy decision entity with information regarding alternate neighboring access networks. This information includes network operator information, candidate priority lists, real radio measurements belonging to the candidate neighbors, or the like. MIH CS and ES may be used to trigger handover and to command handovers.

The MIH functions and its IS, CS and ES may be used as a means to supply VCC functions with real time triggers based on changes occurred at the underlying layers and as a means to allow the CIVCS 118 and the CCCF/NeDS 120 to control the underlying layer at the IP CAN 110.

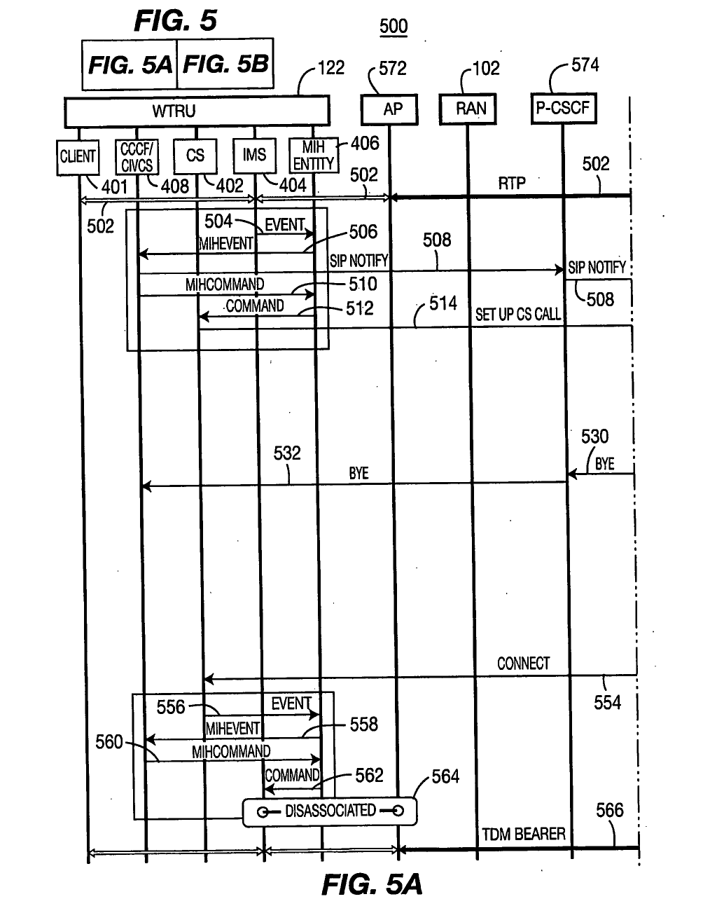

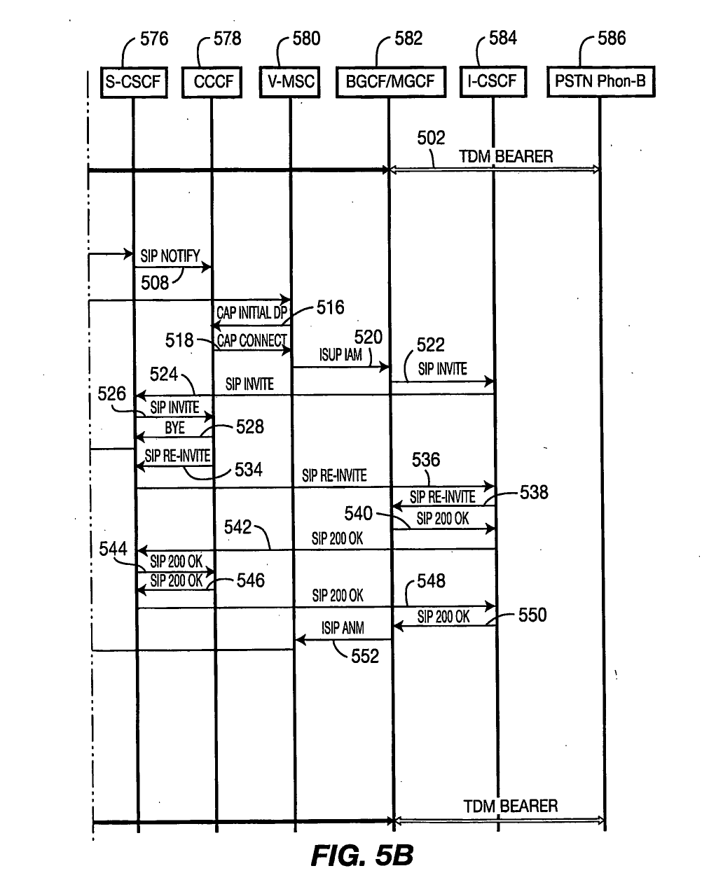

FIG. 5 is a flow diagram of a process 500 of implementing a user-initiated handover from an IMS domain to a CS domain using MIH services in accordance with the present invention. A client 401, (i.e., user), initially establishes a call in an IMS domain and a real time protocol (RTP) connection is established between the IMS interface and a breakout gateway control function (BGCF)/media gateway control function (MGCF) 582, and a time division multiplexing (TDM) bearer is established between the BGCF/MGCF 582 and a PSTN 586 (step 502). The MGCF functions as a gateway between an IMS and the PSTN 586. The MGCF is responsible for the termination of session initiation protocol (SIP) calls and performs conversion between call control signaling and SIP signaling. The BGCF determines which MGCF a call should go through to reach a local PSTN.

As explained hereinbefore, the WTRU 122 includes the CCCF/CIVCS entity 408, the MIH entity 406, the CS interface 402 and the IMS interface 402, (i.e., the IEEE 802 interface 404 assuming that the IP multimedia service is provided via the IEEE 802 IP CAN 110). The IMS interface may be the 3GPP interface if the IP multimedia service is provided via the 3GPP IP CAN 110. The IMS interface 404 sends a handover trigger event to the MIH entity 406 via an ES when it is detected (step 504). The ES is used to trigger a handover, for example, after the underlying resources are either no longer to support the service in the current call domain or new resources have become available to support the service in another call domain with providing an improvement over the current link.

The MIH entity 406 may use native handover commands to trigger handover within a heterogeneous environment. For example, the MIH entity 406 may use an indication from the lower layer, (e.g., measurements indicating unfavorable radio conditions), to trigger a handover toward the CCCF 408. The CCCF 408, (or any other policy function or mobility management function), may map the trigger to an exiting handover messages within the technology that is currently handle the access connection. The CCCF 408 may instruct its counterpart on the network side to trigger a handover via a signaling gateway within an IMS network. The handover command itself is part of an existing mobility technology, (such as the one defined in UMTS). In accordance with the present invention, the trigger coming from one technology is received by the MIH entity 406 and mapped to the other technology.

The MIH entity 406 reports the MIH event to the CCCF/CIVCS entity 408 (step 506). Upon receipt of the MIH event, the CCCF/CIVCS entity 408 sends an SIP NOTIFY message to the CCCF 578 via the P-CSCF 574 and the S-CSCF 576 to notify such intent to handover the call from the IMS domain to the CS domain (step 508). The CCCF/CIVCS entity 408 then sends an MIH command to the MIH entity 406, which sends a command to the CS interface 402 to initiate the handover (steps 510, 512). Upon receipt of the MIH command, the CS interface 402 sets up a CS call with the V-MSC 580 (step 514).

The V-MSC 580 triggers a customized application mobile enhanced logic (CAMEL) application part (CAP) dialogue to the CCCF 578, (i.e., CAP initial DP) (step 516). The CCCF 578 sends a CAP connect message to the V-MSC 580 to continue the CS call to the CCCF 578 (step 518). The V-MSC 580 selects a proper BGCF/MGCF 582 and sends an initial address message (IAM) to the BGCF/MGCF 582 (step 520). When the BGCF/MGCF 582 receives the IAM, the BGCF/MGCF 582 sends an INVITE request to the CCCF 578 via the I-CSCF 584 and the S-CSCF 576 to indicate a user or service is being invited to participate in a call (steps 522, 524, 526).

After receiving the INVITE request from the BGCF/MGCF 582, the CCCF 578 sends a BYE message to the CCCF/CIVCS entity 408 of the WTRU 122 via the S-CSCF 576 and the P-CSCF 574 to terminate the call in the IMS domain (steps 528, 530, 532). The CCCF 578 also sends a REINVITE request to the BGCF/MGCF 582 through the S-CSCF 576 and the I-CSCF 584 (steps 534, 536, 538). The BGCF/MGCF 582 then sends an SIP 200 OK message to the CCCF 578 to confirm the receipt of the REINVITE request through the I-CSCF 584 and the S-CSCF 576 (steps 540, 542, 544). The CCCF 578 also sends an SIP 200 OK message to the BGCF/MGCF 582 to confirm the receipt of the SIP 200 OK message through the S-CSCF 576 and the I-CSCF 584 (steps 546, 548, 550). The BGCF/MGCF 582 sends an answer message (ANM) to the V-MSC 580 (step 552). The V-MSC 580 sends a CONNECT message to the CS interface 402 of the WTRU 122 (step 554).

Upon receipt of the CONNECT message, the CS interface 402 reports the event to the MIH entity 406 (step 556). The MIH entity 406 reports the event to the CCCF/CIVCS entity 408 via MIH ES (step 558). The CCCF/CIVCS entity 408 sends an MIH command to the MIH entity 406 via MIH CS (step 560). The MIH entity 406 then sends a command to the IMS interface 402 step 562). An association with the AP 572 is then disassociated and a new call in the CS domain is established between the CS interface 402 and the PSTN 586 via the RAN 102 and the BGCF/MGCF 582.

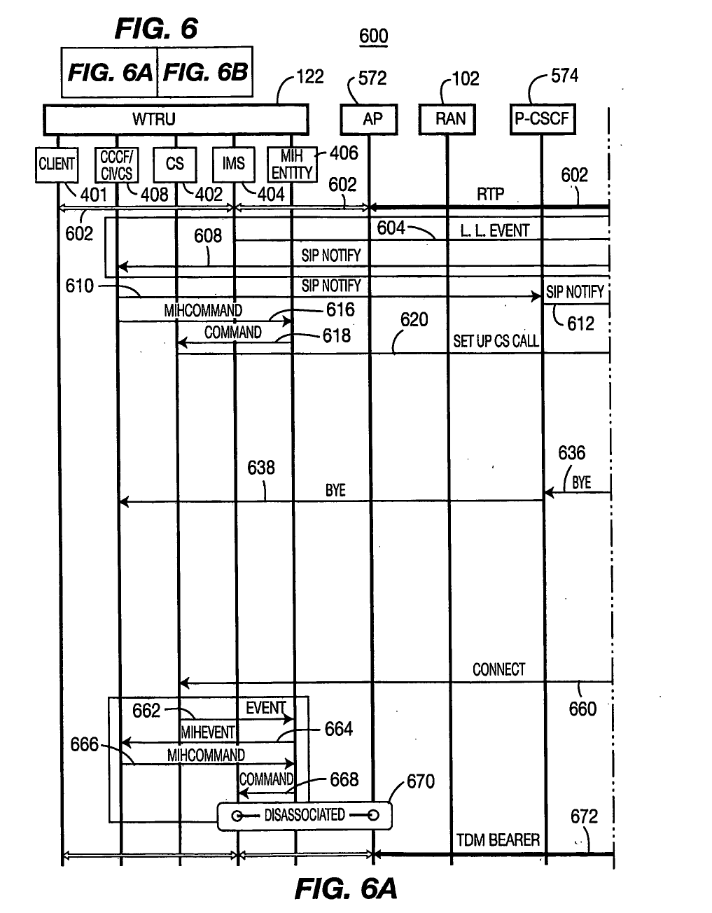

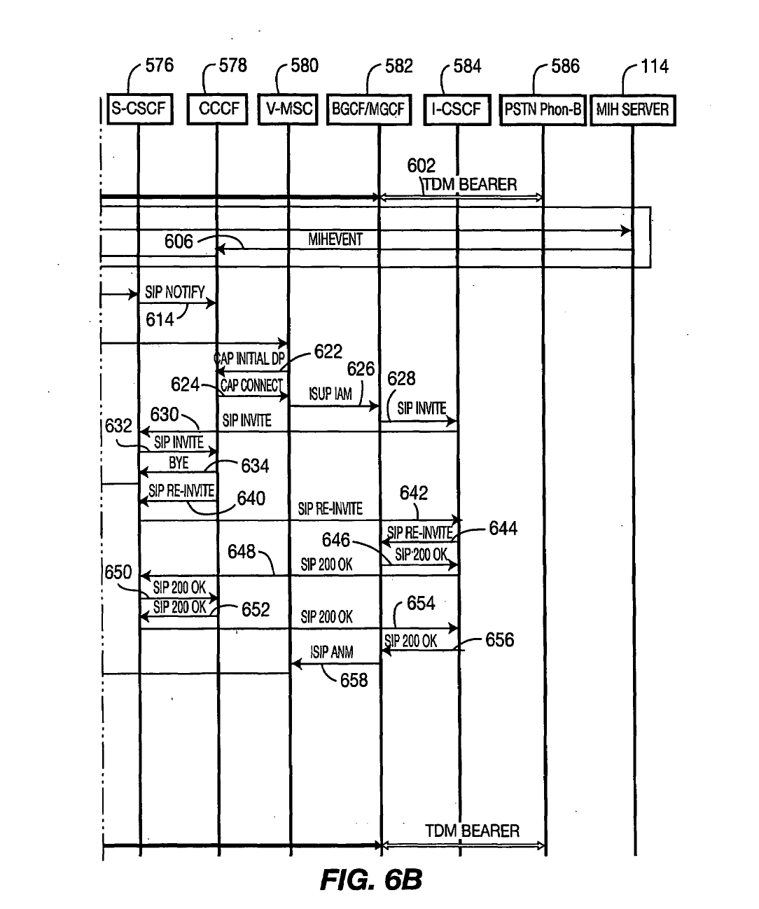

FIG. 6 is a flow diagram of a process 600 of implementing a network-initiated handover from an IMS domain to a CS domain using MIH services in accordance with the present invention. A client 401, (i.e., user), initially establishes a call in an IMS domain and a real time protocol (RTP) connection is established between the IMS interface 404 and a BGCF/MGCF 582, and a TDM bearer is established between the BGCF/MGCF 582 and a PSTN 586 of the other party of the call (step 602).

The MIH information is reported to the MIH information server 114 from the WTRU 122 via the IMS interface 404 (step 604). The MIH information server 114 reports the MIH event to the CCCF 578 (step 606). Upon receipt of the MIH event, the CCCF 578 sends an SIP NOTIFY message to the CCCF/CIVCS entity 408 (step 608). The CCCF/CIVCS entity 408 then sends an SIP NOTIFY message to the CCCF 578 through the P-CSCF 574 and the S-CSCF 576 (steps 610, 612, 614). The CCCF/CIVCS entity 408 also sends an MIH command to the MIH entity 406, which sends an MIH command to the CS interface 402 to initiate a handover of the call from the IMS domain to the CS domain (steps 616, 618). Upon receipt of the MIH command, the CS interface 402 sets up a CS call with the V-MSC 580 (step 620).

The V-MSC 580 triggers a CAP dialogue to the CCCF 578, (i.e., CAP initial DP) (step 622). The CCCF 578 sends a CAP connect message to the V-MSC 580 to continue the CS call to the CCCF 578 (step 624). The V-MSC 580 selects a proper BGCF/MGCF 582 and sends an IAM message to the BGCF/MGCF 582 (step 626). The BGCF/MGCF 582 sends an INVITE request t the CCCF 578 via the I-CSCF 584 and the S-CSCF 576 (steps 628, 630, 632).

After receiving the INVITE request from the BGCF/MGCF 582, the CCCF 578 sends a BYE message to the CCCF/CIVCS entity 408 of the WTRU 122 via the S-CSCF 576 and the P-CSCF 574 (steps 634, 636, 638). The CCCF 578 also sends a REINVITE request to the BGCF/MGCF 582 through the S-CSCF 576 and the I-CSCF 584 (steps 640, 642, 644). The BGCF/MGCF 582 then sends an SIP 200 OK message to the CCCF 578 through the I-CSCF 584 and the S-CSCF 576 (steps 646, 648, 650). The CCCF 578 then sends an SIP 200 OK message to the BGCF/MGCF 582 through the S-CSCF 576 and the I-CSCF 584 (steps 652, 654, 656). The BGCF/MGCF 582 sends an ANM message to the V-MSC 580 (step 658). The V-MSC 580 sends a CONNECT message to the CS interface 402 of the WTRU 122 (step 660).

Upon receipt of the CONNECT message, the CS interface 402 reports the event to the MIH entity 406 (step 662). The MIH entity 406 reports the event to the CCCF/CIVCS entity 408 via MIH ES (step 664). The CCCF/CIVCS entity 408 sends an MIH command to the MIH entity 406 via MIH CS (step 666). The MIH entity 406 then sends a command to the IMS interface 404 (step 668). An association with the AP 572 is then disassociated and a new call in the CS domain is established between the CS interface 402 and the PSTN 586 via the RAN 102 and the BGCF/MGCF 582.

### Embodiments

1. A wireless communication system for supporting a handover between a circuit-switched (CS) domain and an Internet protocol (IP) multimedia subsystem (IMS) domain for supporting call continuity, the system comprising:

a wireless transmit/receive unit (WTRU) including:
a first call continuity control entity for supporting call continuity between the CS domain and the IMS domain by triggering a handover between the CS domain and the IMS domain;
a CS interface for supporting a call in the CS domain;
an IMS interface for supporting a call in the IMS domain; and
a first media independent handover (MIH) entity configured to provide MIH services for collecting and forwarding information in a media independent manner; and

a wireless network comprising:
a CS network for providing CS services;
an IMS for providing IP multimedia services, the IMS including a second call continuity control entity for call continuity between the CS domain and the IMS domain and a network domain selection (NeDS) entity for selecting one of the CS domain and the IMS domain for the call; and
a second MIH entity for providing MIH services for collecting and forwarding information in a media independent manner, whereby a handover between the CS domain and the IMS domain is performed based on information obtained via MIH services provided by at least one of the first MIH entity and the second MIH entity.

2. The system of embodiment 1 wherein the MIH services provided by the first MIH entity collect and forward local information obtained from at least one of the CS interface and the IMS interface.

3. The system as in any one of embodiments 1 and 2 wherein the MIH services provided by the first MIH entity collect and forward remote information obtained from the wireless network.

4. The system as in any one of embodiments 1-3 wherein the handover is initiated by the WTRU.

5. The system as in any one of embodiments 1-4 further comprising an MIH information server configured to exchange the information between the WTRU and the second call continuity control entity and the NeDS entity.

6. The system of embodiment 5 wherein the MIH information server provides the NeDS entity with information regarding media types supported by the WTRU, whereby the NeDS entity selects the domain based on the media types supported by the WTRU.

7. The system of embodiment 6 wherein the media types include at least one of voice and video capabilities over the IMS, voice capabilities over the CS network, and a codec type.

8. The system of embodiment 5 wherein the MIH information server provides the NeDS entity with information regarding WTRU status with respect to the CS network.

9. The system of embodiment 8 wherein the WTRU status includes at least one of a detached state, an attached-idle state and an attached-active state.

10. The system of embodiment 5 wherein the MIH information server provides neighboring information and location information of the WTRU to the NeDS entity, whereby the NeDS entity assigns the WTRU with a most suitable call continuity control entity.

11. The system of embodiment 10 wherein the NeDS entity assigns the WTRU with a call continuity control entity based on at least one of geographical location of the WTRU, user and operator preferences and quality of service (QoS) of the available networks.

12. The system of embodiment 5 wherein a fully qualified domain name (FQDN) of the MIH information server is used to discover an associated proxy call session control function (P-CSCF).

13. The system of embodiment 5 wherein the MIH services are used to provide relevant filter criteria in a service profile of a user.

14. The system of embodiment 5 wherein the MIH information server is an IMS application server.

15. The system of embodiment 14 wherein the IMS application server performs a policy decision function and information obtained via the MIH services is used in policy decision.

16. The system as in any one of embodiments 1-15 wherein handover triggering event is provided via the MIH services such that a handover decision is made in real time.

17. The system of embodiment 5 wherein the MIH information server includes the call continuity control entity and the NeDS entity.

18. The system of embodiment 5 wherein the call continuity control entity and the NeDS entity includes an MIH information server, respectively.

19. The system as in any one of embodiments 1-18 wherein the CS network is a third generation partnership project (3GPP) network.

20. The system as in any one of embodiments 1-19 wherein the IP multimedia services are provided via an IP connectivity access network (CAN) with a wireless local area network (WLAN).

21. The system as in any one of embodiments 1-20 wherein the WLAN is an IEEE 802-based network.

22. The system as in any one of embodiments 1-21 wherein the IP multimedia services are provided via a third generation partnership project (3GPP) network.

23. In a wireless communication system including a wireless transmit/receive unit (WTRU) and a wireless network including a circuit-switched (CS) network for supporting CS services and an Internet protocol (IP) multimedia subsystem (IMS) for supporting IP multimedia services, wherein a call may be established in at least one of a CS domain and an IMS domain, a method for a handover between the CS domain and the IMS domain for seamless continuity of the call, the method comprising:

obtaining information using media independent handover (MIH) services; and

triggering a handover for the call between the CS domain and the IMS domain based on the information.

24. The method of embodiment 23 wherein the information includes local information obtained from at least one of a CS interface and an IMS interface of the WTRU.

25. The method as in any one of embodiments 23 and 24 wherein the information includes local information obtained by the wireless network.

26. The method of embodiment 24 wherein the information includes remote information exchanged between the WTRU and the wireless network.

27. The method as in any one of embodiments 23-26 wherein the handover is triggered by the WTRU.

28. The method as in any one of embodiments 23-27 wherein the handover is triggered by the wireless network.

29. The method as in any one of embodiments 23-28 wherein the information is exchanged between the WTRU and the wireless network via an MIH information server.

30. The method of embodiment 29 wherein the MIH information server provides a network domain selection (NeDS) entity in the wireless network with information regarding media types supported by the WTRU, whereby the NeDS entity selects the domain based on the media types supported by the WTRU.

31. The method of embodiment 30 wherein the media types include at least one of voice and video capabilities over the IMS, voice capabilities over the CS network, and a codec type.

32. The method of embodiment 29 wherein the MIH information server provides a network domain selection (NeDS) entity in the wireless network with information regarding WTRU status with respect to the CS network.

33. The method of embodiment 32 wherein the WTRU status includes at least one of a detached state, an attached-idle state and an attached-active state.

34. The method of embodiment 29 wherein the MIH information server provides neighboring information and location information of the WTRU to a network domain selection (NeDS) entity in the wireless network, whereby the NeDS entity assigns the WTRU with a most suitable call continuity control entity.

35. The method of embodiment 34 wherein the NeDS entity assigns the WTRU with a call continuity control entity based on at least one of geographical location of the WTRU, user and operator preferences and quality of service (QoS) of the available networks.

36. The method of embodiment 29 wherein a fully qualified domain name (FQDN) of the MIH information server is used to discover an associated proxy call session control function (P-CSCF).

37. The method of embodiment 29 wherein the information includes relevant filter criteria in a service profile of a user of the WTRU.

38. The method of embodiment 29 wherein the MIH information server is an IMS application server.

39. The method of embodiment 38 further comprising:

the IMS application server performing a policy decision function based on the information obtained via the MIH services.

40. The method as in any one of embodiments 23-39 wherein the information includes a handover triggering event provided via the MIH services such that the handover is triggered in real time.

41. The method as in any one of embodiments 23-40 wherein the CS network is a third generation partnership project (3GPP) network.

42. The method as in any one of embodiments 23-41 wherein the IP multimedia services are provided via an IP connectivity access network (CAN) with a wireless local area network (WLAN).

43. The method as in any one of embodiments 23-42 wherein the WLAN is an IEEE 802-based network.

44. The method as in any one of embodiments 23-43 wherein the IP multimedia services are provided via a third generation partnership project (3GPP) network.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A wireless communication system for supporting a handover between a circuit-switched (CS) domain and an Internet protocol (IP) multimedia subsystem (IMS) domain for supporting call continuity, the system comprising:
a wireless transmit/receive unit (WTRU) including:
a first call continuity control entity for supporting call continuity between the CS domain and the IMS domain by triggering a handover between the CS domain and the IMS domain;
a CS interface for supporting a call in the CS domain;
an IMS interface for supporting a call in the IMS domain; and
a first media independent handover (MIH) entity configured to provide MIH services for collecting and forwarding information in a media independent manner; and
a wireless network comprising:
a CS network for providing CS services;
an IMS for providing IP multimedia services, the IMS including a second call continuity control entity for call continuity between the CS domain and the IMS domain and a network domain selection (NeDS) entity for selecting one of the CS domain and the IMS domain for the call; and
a second MIH entity for providing MIH services for collecting and forwarding information in a media independent manner, whereby a handover between the CS domain and the IMS domain is performed based on information obtained via MIH services provided by at least one of the first MIH entity and the second MIH entity.

2. The system of claim 1 wherein the MIH services provided by the first MIH entity collect and forward local information obtained from at least one of the CS interface and the IMS interface.

3. The system of claim 2 wherein the MIH services provided by the first MIH entity collect and forward remote information obtained from the wireless network.

4. The system of claim 1 wherein the handover is initiated by the WTRU.

5. The system of claim 1 further comprising an MIH information server configured to exchange the information between the WTRU and the second call continuity control entity and the NeDS entity.

6. The system of claim 5 wherein the MIH information server provides the NeDS entity with information regarding media types supported by the WTRU, whereby the NeDS entity selects the domain based on the media types supported by the WTRU.

7. The system of claim 6 wherein the media types include at least one of voice and video capabilities over the IMS, voice capabilities over the CS network, and a codec type.

8. The system of claim 5 wherein the MIH information server provides the NeDS entity with information regarding WTRU status with respect to the CS network.

9. The system of claim 8 wherein the WTRU status includes at least one of a detached state, an attached-idle state and an attached-active state.

10. The system of claim 5 wherein the MIH information server provides neighboring information and location information of the WTRU to the NeDS entity, whereby the NeDS entity assigns the WTRU with a most suitable call continuity control entity.

11. The system of claim 10 wherein the NeDS entity assigns the WTRU with a call continuity control entity based on at least one of geographical location of the WTRU, user and operator preferences and quality of service (QoS) of the available networks.

12. The system of claim 5 wherein a fully qualified domain name (FQDN) of the MIH information server is used to discover an associated proxy call session control function (P-CSCF).

13. The system of claim 5 wherein the MIH services are used to provide relevant filter criteria in a service profile of a user.

14. The system of claim 5 wherein the MIH information server is an IMS application server.

15. The system of claim 14 wherein the IMS application server performs a policy decision function and information obtained via the MIH services is used in policy decision.

16. The system of claim 1 wherein handover triggering event is provided via the MIH services such that a handover decision is made in real time.

17. The system of claim 5 wherein the MIH information server includes the call continuity control entity and the NeDS entity.

18. The system of claim 5 wherein the call continuity control entity and the NeDS entity includes an MIH information server, respectively.

19. The system of claim 1 wherein the CS network is a third generation partnership project (3GPP) network.

20. The system of claim 1 wherein the IP multimedia services are provided via an IP connectivity access network (CAN) with a wireless local area network (WLAN).

21. The system of claim 20 wherein the WLAN is an IEEE 802-based network.

22. The system of claim 1 wherein the IP multimedia services are provided via a third generation partnership project (3GPP) network.

23. In a wireless communication system including a wireless transmit/receive unit (WTRU) and a wireless network including a circuit-switched (CS) network for supporting CS services and an Internet protocol (IP) multimedia subsystem (IMS) for supporting IP multimedia services, wherein a call may be established in at least one of a CS domain and an IMS domain, a method for a handover between the CS domain and the IMS domain for seamless continuity of the call, the method comprising:
obtaining information using media independent handover (MIH) services; and
triggering a handover for the call between the CS domain and the IMS domain based on the information.

24. The method of claim 23 wherein the information includes local information obtained from at least one of a CS interface and an IMS interface of the WTRU.

25. The method of claim 23 wherein the information includes local information obtained by the wireless network.

26. The method of claim 24 wherein the information includes remote information exchanged between the WTRU and the wireless network.

27. The method of claim 23 wherein the handover is triggered by the WTRU.

28. The method of claim 23 wherein the handover is triggered by the wireless network.

29. The method of claim 23 wherein the information is exchanged between the WTRU and the wireless network via an MIH information server.

30. The method of claim 29 wherein the MIH information server provides a network domain selection (NeDS) entity in the wireless network with information regarding media types supported by the WTRU, whereby the NeDS entity selects the domain based on the media types supported by the WTRU.

31. The method of claim 30 wherein the media types include at least one of voice and video capabilities over the IMS, voice capabilities over the CS network, and a codec type.

32. The method of claim 29 wherein the MIH information server provides a network domain selection (NeDS) entity in the wireless network with information regarding WTRU status with respect to the CS network.

33. The method of claim 32 wherein the WTRU status includes at least one of a detached state, an attached-idle state and an attached-active state.

34. The method of claim 29 wherein the MIH information server provides neighboring information and location information of the WTRU to a network domain selection (NeDS) entity in the wireless network, whereby the NeDS entity assigns the WTRU with a most suitable call continuity control entity.

35. The method of claim 34 wherein the NeDS entity assigns the WTRU with a call continuity control entity based on at least one of geographical location of the WTRU, user and operator preferences and quality of service (QoS) of the available networks.

36. The method of claim 29 wherein a fully qualified domain name (FQDN) of the MIH information server is used to discover an associated proxy call session control function (P-CSCF).

37. The method of claim 29 wherein the information includes relevant filter criteria in a service profile of a user of the WTRU.

38. The method of claim 29 wherein the MIH information server is an IMS application server.

39. The method of claim 38 further comprising:
the IMS application server performing a policy decision function based on the information obtained via the MIH services.

40. The method of claim 23 wherein the information includes a handover triggering event provided via the MIH services such that the handover is triggered in real time.

41. The method of claim 23 wherein the CS network is a third generation partnership project (3GPP) network.

42. The method of claim 23 wherein the IP multimedia services are provided via an IP connectivity access network (CAN) with a wireless local area network (WLAN).

43. The method of claim 42 wherein the WLAN is an IEEE 802-based network.

44. The method of claim 23 wherein the IP multimedia services are provided via a third generation partnership project (3GPP) network.
